(19) United States
(12) Patent Application Publication
(10) Pub. No.: US 2006/0200386 A1
(43) Pub. Date: Sep. 7, 2006

(54) Accessing accessibility process

(76) Inventor: Dorothy M. Hartman, Philadelphia, PA (US)

Correspondence Address: Dorothy M. Hartman, 822 So. 5th St. (FR.), Philadelphia, PA, 19147, US

(21) Appl. No.: 11/003,123

(22) Filed: Mar. 7, 2005

(51) Int. Cl. G06Q 30/00

(52) U.S. Cl. 705/26

(57) ABSTRACT

This is a new business process where the computer is used as an integral part of a business transaction. Data retrieval, the delivery of goods and services from a remote site are made available by the operation of the computer and modem. These are exchanged by the proprietor of the database and/or merchant and the end-user or consumer. This enhances commerce as it increases the consumer's exposure to number and variety of products and increases the market's ability to maximize the number of consumers that it can reach. This accessibility increases convenience and makes time available to the end-user. If more consumers have more access and more opportunity to purchase this boosts the commercial potential of the economy. It creates a unique market with enormous growth potential as its existence is in cyberspace. It is useful for social communication with the use electronic mail being adaptive to sight and sound with cameras and speakers.

This invention is a new and revolutionary business process in which the computer by way of a modem is used to access, retrieve, and exchange goods, services, and information. It is a new method whereby information can be brokered and the exchange of goods and services used for commercial profit. This enhances the user's access to greater information in a shorter period of time without having to be physically present in order for the transaction to occur. It creates a network in which businesses have additional opportunities to reach consumers. The accessibility to goods and services is magnified. It makes time management easier and can substantially reduce costs as the user need not spend time or effort in traveling or send messengers to accomplish the task.

Information retrieval for the first time can be used for a commercial exchange between a database or website and the average consumer. It encourages the creation of databases or websites which can be set up to advertise products and services. These web pages also provide sites or addresses in cyberspace where the end-user or consumer may accomplish the transaction or simply download the desired information. It also makes possible global communication as the computer uses its modem via telephone, cable wires, or wireless radio signals into cyberspace making contact almost instantaneous.

This new process was introduced in a business plan and similar writings in 1990 by the inventor. These documents are enclosed on the CD entitled Hartman Patent Docs. #1-12 and are comprised of the following: (1) Accessing Accessibility (Marketing Information and Service Brokerage)—11 pages submitted 1991-1992 for Innovation Award Ben Franklin Partnership Program of the Commonwealth of Pennsylvania; (2) The Feasibility of Accessing Accessibility submitted March 1991 to Pennsylvania Department of Commerce for Benjamin Franklin Partnership Fund Project; (3) Talk Shoppe Telecommunications Services business offering Information Retrieval application for registration of fictitious name—Mar. 5, 1990; (4) Hartman letter to Frank Campo—U.S. Small Business Administration Sep. 27, 1990; (5) Hartman letter to Twanna Bivins, P.C.D.C. May 31, 1990; (6) Hartman letter to Don Lonergan LaSalle Small Business Development Center, Feb. 13, 1990; (7) Hartman letter to Shelly Fudge Benjamin Franklin Technology Center of Southeastern Pennsylvania, Aug. 23, 1990; (8) Hartman letter to Phillip A. Singerman, Benjamin Franklin Technology Center of Southeastern Pennsylvania, Mar. 30, 1991; (9) William H. Harrington, Director of Benjamin Franklin Technology Center of Southeastern Pennsylvania letter to Hartman, Aug. 15, 1991; (10) U.S. Small Business Administration letter to Hartman, Aug. 5, 1992; (11) U.S. Small Business Administration letter to Hartman, Aug. 20, 1992; (12) Certified Mail envelopes from U.S. Business Administration to Hartman dated Aug. 21, 1992 and Jan. 22, 1993.

This process Accessing Accessibility is a method in which an end-user logs on to a website on a remote computer; accesses goods, services, or information; carries out a transaction, retrieves or downloads information and logs off. This can be accomplished by the use of a computer and a modem. The steps of this process can be illustrated as follows: a Simple Step as illustrated in FIG. 1 where a sole consumer logs onto a single website; carries out transactions and logs off. FIG. 2 illustrates Multiple Steps where a single consumer logs onto multiple websites for multiple transactions and logs off. FIG. 3 illustrates a third party broker who accesses websites in lieu of the consumer who does not have access to a computer for which the broker receives a fee for services.

These steps can be continued into a web or network of numerous steps of this process all occurring at the same time. The consumer or end-user may log onto a website to retrieve information or services. Simultaneously or at separate times the website can log-on and contact the consumer or end-user. Similarly end-users can log-on and contact the website or other end-users directly by chatting across the electronic keyboards. The computer may deliver this electronic mail instantly or at separate times. The infinitude of cyberspace makes all of these actions possible at the same time thereby making telecommunication highly accessible with the keystrokes of a computer and modem. This accessibility is adaptable to sight and sound by the use of cameras and audio capability. FIG. 4 illustrates this by showing multiple end-users all accessing various websites or other end-users simultaneously forming a telecommunications web or network.

The steps in the process consist of logging onto the remote location or website by accessing the computer's ability to send messages via its modem over telephone and cable wires or through wireless technology. This is generally accomplished by specific software designed to enable the computer to contact various websites. The user accomplishes his or her objective and then logs off or essentially hangs up. Logging on and logging off can be accomplished at any time that the end-user decides to or the remote computer can do so depending upon its program. The Simple Step in the process is represented in FIG. 1 where the end-user or consumer logs on to desired website, achieves transaction (for example airline reservations) or downloads information (such as scheduling) and then logs off. FIG. 2 illustrates that the end-user may carry out Multiple Steps by visiting several websites usually sequentially before logging off. While visiting at those websites or databases the consumer may accomplish a variety of tasks of which the illustration shows certain examples. Numerous databases may exist offering a variety of information, services, and goods for sale. FIG. 3 shows a commercial set-up whereby a broker or third party purchases services, goods or information and then in turn delivers this information goods or services to a consumer who does not have access to a computer. The broker or computer marketing consultant carries out multiple steps of the process by accessing various databases and services reflecting the needs and desires of his or her clients.

FIG. 4 shows a series of multiple steps of the Accessing Accessibility Process wherein the numerous end-users may log-on to numerous websites simultaneously or end-users may connect with other end-users by text messages or electronic mail. All of these steps of the Accessing Accessibility Process working together and occurring across a web or network simultaneously comprise the INTERNET.

### BRIEF DESCRIPTION OF THE DRAWINGS

FIG. 1 is a diagram which shows how a single end-user with a computer and modem can connect to a single website and conduct a transaction and/or download information.

FIG. 2 is a diagram illustrating a single end-user with a computer and modem connecting to multiple websites, conducting multiple transactions and/or downloading information.

FIG. 3 is a diagram which shows multiple steps wherein an end-user connects to multiple websites except the end-user is a broker who is selling his services to a consumer who does not have access to a computer. In this diagram the broker is a third party or liaison between the website and the consumer.

FIG. 4 is a diagram illustrating a series of multiple steps in which websites may be connected to each other; end-users may be connected to websites; end-users may be connected to other end-users simultaneously. This forms a web or network.

### BRIEF DESCRIPTION OF INVENTION

A process whereby a user through a computer and its modem interfaces with information stored on a website at a remote computer or interfaces with another user on a remote computer. This process enables the user to access and retrieve information and/or allows user to carry out transactions for the purchase of goods and services from a remote site without having to be physically present in order to communicate or carry out the transaction(s). It enables the user to access and carry out conversations with another user(s) at a remote computer by the sending and receiving of text messages or electronic mail. It makes telecommuting likely by allowing workers to converse and participate at a distance from each other and from their jobs by working directly from computers to share files and labor. This invention makes teleconferencing likely with multiple parties participating at the same time across a network of computers. It further enables a multiplicity of transactions to occur simultaneously—users interfacing with multiple websites or with other users. Transactions are occurring in cyberspace making the number of transactions infinite limited only by the technology itself—the capability of machinery hardware and the availability of software.

### BACKGROUND OF THE INVENTION

This invention pertains to expanding the use of computers which heretofore were used primarily for the creation of and storage of records and files and to do computations. Their major jobs being the input, processing, and retrieval of data and the building and maintaining of databases which helped with storage space by the elimination of paper files. These databases also provided a more permanent method of storage for records as data could be more readily destroyed by fire or other methods on paper, tape, or film.

Some databases like Dow Jones News Retrieval and MCIMAIL specialized primarily to corporate consumers. Databases like Compuserve provided bulletin boards where the computer literate and a small community of text messengers could post messages to each other. This invention spurs the development of consumer friendly databases and encourages the production of more commercial databases or websites by making telecommunications accessible to the ordinary citizen or consumer.

The use of telephone, cable wires and even radio transmissions had existed for a number of years making telecommunications possible for the previous 50 years or more. However all of this technology had been limited in its previous applications and under utilized until the onset of this invention. The telephone and radio in their prior capacities and cable in its use in television were underutilized. Wireless technology and radio transmission outside of commercial radio stations were primarily used in a military capacity.

With the exception of the growth of gigantic databases like Dow Jones News Retrieval which was more or less geared to corporations and Wall Street, the technology of creating websites was basically stagnant. The advent of this process Accessing Accessibility which proposes using telecommunications for the desires and needs of ordinary consumers and providing access to cyberspace for them while at the same time increasing commercial opportunities catalyzes the field of telecommunications. This process provides a method which melds all the previous technologies like the telephone, television, and radio together taking each of these technologies to new heights and uses. This new idea(s) revolutionizes the field of telecommunications. Growth and evolution in the use of telephones, radio transmitters, and other electronic and technological gadgetry will continue to increase as a result of this revolutionary process Accessing Accessibility and the invention of the INTERNET. Communication and tasks that at one time may have only been possible by long transcontinental airplane flights or oceanic voyages are now possible electronic strokes on a keyboard making global communication almost instantaneous.

### SUMMARY OF THE INVENTION

The process of Accessing Accessibility by using the computer as much more than storage but a communications tool with the capacity for immediate responses and/or the completion of an actual transaction has revolutionized man's ability to communicate and carry out business transactions over a distance without leaving the place of origin of his correspondence. The introduction of this invention in 1990 which led to the formation of the INTERNET is by far the most reaching and revolutionary use of telecommunications. It ushers in the “Information age” making global communications possible in an instant. It makes possible a more commercialized seemingly smaller world with more countries involved and advancing in education, technology, and growth. This invention is a method which has achieved an intermarriage of preexisting telecommunications technologies which makes possible a telecommunications boom which will continue to evolve for years to come as Cyberspace is infinite with only the confines of the hardware and software to slowdown the technology and the refinement of monitoring techniques to continue its progress.

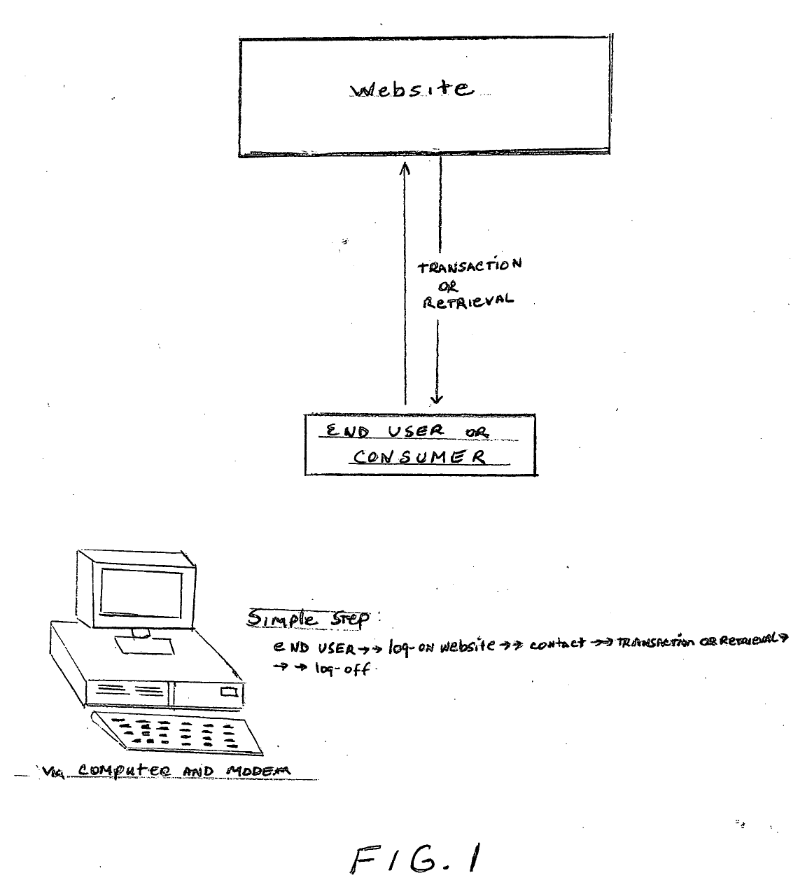

1. Claim one as seen in FIG. 1 comprises a user at a computer who logs onto a remote website by using modem. It comprises user being able to access information at that website. Information may be simply viewed for knowledge or research purposes. Information may be downloaded also via modem from remote database to user's computer. User may view commercial databases for the purpose of purchasing Information, goods, or services. These goods may be paid for by credit card, check or money order or some other means agreed upon by website proprietor and user.

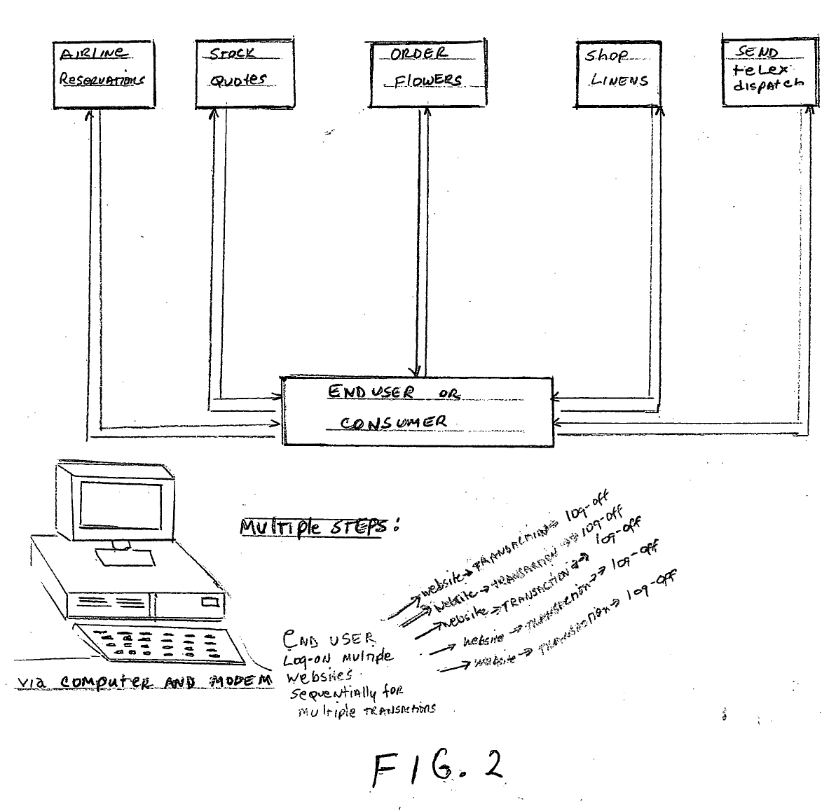

2. Claim 2 as viewed in FIG. 2 comprises a user accessing multiple websites. The user Is therefore able to view a variety of websites and accomplish a variety of tasks. Examples of tasks that a user might engage in on one occasion of logging-on might be to reserve a seat on an airline flight; view stock quotes; order flowers; shop for linens; send a telex dispatch. The user may view whatever websites are available by the modem's calling capability and the computer's software and may log-on and log-off at will.

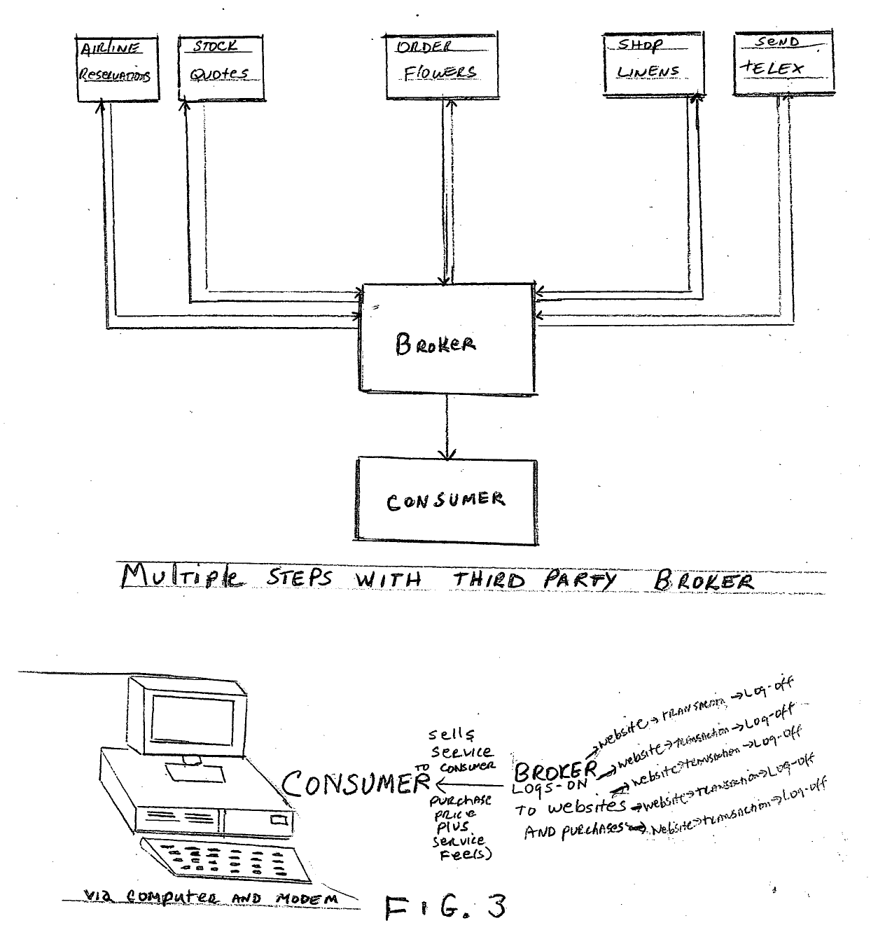

3. Claim 3 as illustrated in FIG. 3 shows how in this process a broker or third party may intervene for the user or consumer who does not have access to a computer. The broker may instead visit the websites, view and/or retrieve data, purchase goods or services and transfer them to the consumer for a fee.

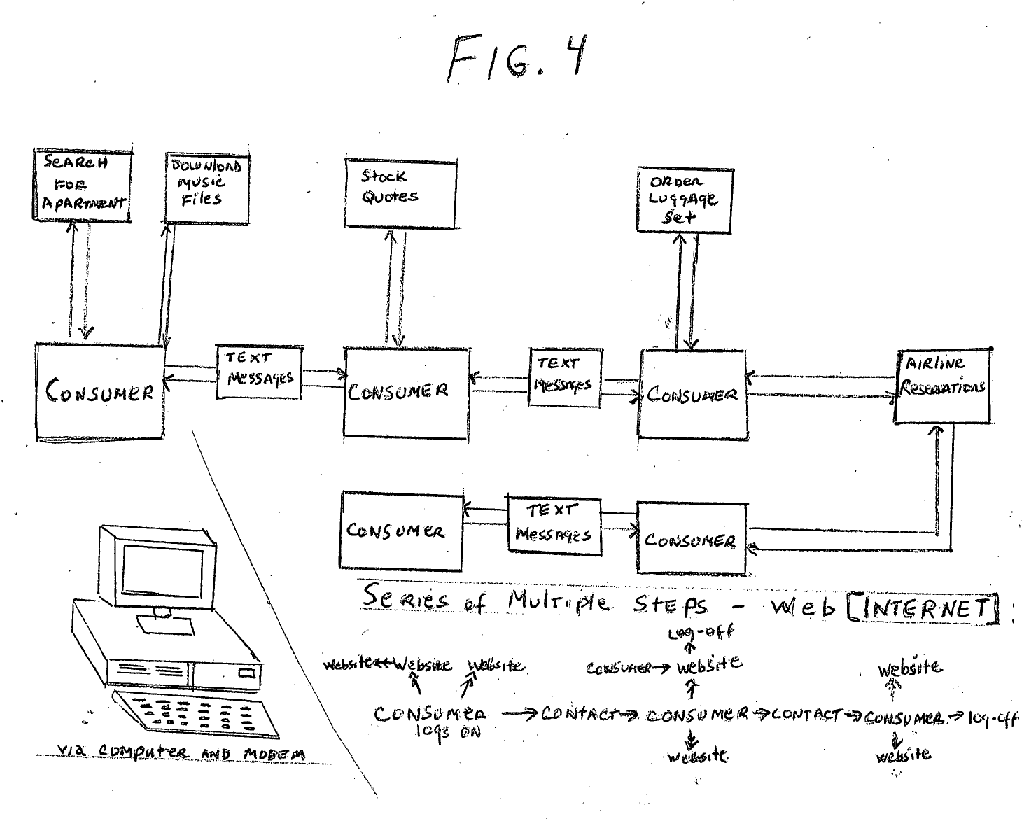

4. Claim 4 in FIG. 4 comprises several users interfacing with websites or with other users. The users may elect to visit various websites to browse, download, or purchase or they may elect to contact and chat with other users through text messaging or electronic mail. A series of multiple steps of this process comprise a web or network {INTERNET}.
